(19) United States
(12) Patent Application Publication
(10) Pub. No.: US 2006/0144895 A1
(43) Pub. Date: Jul. 6, 2006

(54) Stapler with improved base and cover construction

(75) Inventors: David W. Kirby, Lemont, IL (US); Robert C. Coon, Chicago, IL (US); Stephen J. Gaynes, McHenry, IL (US)

Correspondence Address: MICHAEL BEST & FRIEDRICH, LLP, 100 E WISCONSIN AVENUE, MILWAUKEE, WI, 53202, US

(73) Assignee: ACCO Brands, Inc., Lincolnshire, IL (US)

(21) Appl. No.: 11/194,513

(22) Filed: Aug. 1, 2005

Related U.S. Application Data
(63) Continuation-in-part of application No. 29/202,704, filed on Apr. 2, 2004, now Pat. No. D511283.

(51) Int. Cl. B25C 5/02

(52) U.S. Cl. 227/134

(57) ABSTRACT

A stapler configured such that the stapler can be used both as a desktop-type stapler and as a hand-held stapler. The stapler includes a base, a staple magazine pivotably coupled to the base, a cover assembly coupled to the base, and a staple driver coupled to the cover assembly. The base includes a front end, a rear end, a top surface, and a bottom surface. The bottom surface includes a first flat portion near the front end of the base, a second flat portion near the rear end of the base, and a recess positioned between the first and second flat portions such that the flat portions and the recess together extend along the entirety of the base length. The recess includes a curved portion that extends across the width of the stapler base and is raised upwardly from a plane defined by the flat portions along the entire length between the first and second flat portions.

### RELATED APPLICATIONS

This application is a continuation-in-part of co-pending U.S. patent application Ser. No. 29/202,704, filed Apr. 2, 2004, the entire contents of which are incorporated by reference herein.

### FIELD OF THE INVENTION

The invention relates to staplers, and more specifically to a stapler base and cover construction.

### BACKGROUND OF THE INVENTION

Staplers are known to have bases with varying configurations. For example, some desktop staplers have a flat base including a rubber slipper such that the stapler sits flat on a desk or other surface. In these desktop staplers, it is desirable to maximize the stability of the stapler on the support surface for optimum stapling function. Other staplers are designed to be picked up and gripped by the user during the stapling operation, and may include flat nose pieces such that the stapler stands vertically upright when resting on a surface. In staplers that are designed to be gripped by the user, it is desirable to provide a stapler having an overall geometry that makes it easier for the user to grip and use the stapler, while also maximizing support and guidance of the stapler to provide for more accurate stapling.

### SUMMARY OF THE INVENTION

However, in some cases it is desirable to provide a stapler that is capable both of having the stability to be utilized as a desktop stapler, as well as having a geometry such that the stapler can be gripped and used as a hand-held stapler. Such a stapler should utilize a geometry that enhances both desktop stability as well as ease and comfort of use while the stapler is being gripped.

The present invention includes a stapler having a base, a staple magazine pivotably coupled to the base and configured to hold staples, a cover assembly coupled to the base for movement during stapling operations, and a staple driver coupled to the cover assembly. In one aspect, the base defines a base length and a base width and includes a front end, a rear end, a top surface, and a bottom surface. The bottom surface includes a first flat portion near the front end of the base, a second flat portion near the rear end of the base, and a recess positioned between the first and second flat portions such that the first and second flat portions and the recess together extend along the entirety of the base. The recess includes a curved portion that extends across the entire width of the base, and is raised upwardly from a plane defined by the first and second flat portions along the entire length between the first and second flat portions.

In another aspect, the geometry of the base is configured to enhance both desktop stability and comfort of use as a hand-held stapler. That enhancement is represented by the ratio of the length of the first and second flat portions to the length of the recess. In one embodiment, the ratio is greater than or equal to about 1:1, and less than or equal to about 2:1. In another embodiment, the ratio is about 1.3:1.

In another aspect of the invention, the cover has a front surface that defines a plane that substantially intersects a front surface of the base. The combined length of the first and second flat portions is greater than or equal to about 40% of the base length, and is less than or equal to about 80% of the base length.

The present invention also includes a stapler configured such that the stapler can be used both as a desktop-type stapler and as a hand-held stapler. The stapler includes a base having a first end and a second end, a staple magazine coupled to the base and configured to hold staples, and a cover assembly coupled to the magazine. The cover assembly includes a cover that can be depressed by a user to actuate the stapler. The cover includes a first end adjacent the first end of the base, the first end having a first width and a second width, and the first end having a first radius of curvature in a convex direction in a plane defining a longitudinal cross section of the stapler, and a second end adjacent the second end of the base, the second end having a width and having a second radius of curvature in a concave direction in the plane defining the longitudinal cross section of the stapler. The first width of the first end is greater than the width of the second end, and wherein the convex radius of curvature is less than the concave radius of curvature.

Other features and advantages of the invention will become apparent to those skilled in the art upon review of the following detailed description and drawings.

### BRIEF DESCRIPTION OF THE DRAWINGS

FIG. 1 is perspective view of a stapler embodying the invention.

FIG. 2 is a side view of the stapler of FIG. 1.

FIG. 3 is a perspective view of the stapler of FIG. 1 in the open position.

FIG. 4 is a side view of the stapler of FIG. 1 being gripped by a user.

FIG. 5 is a front partial section view of the stapler of FIG. 1, with a section of the base taken through line 5-5 of FIG. 4.

FIG. 6 is a top view of the stapler of FIG. 1.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including”, “having”, and “comprising” and variations thereof herein is meant to encompass the items listed thereafter and equivalents thereof as well as additional items.

### DETAILED DESCRIPTION

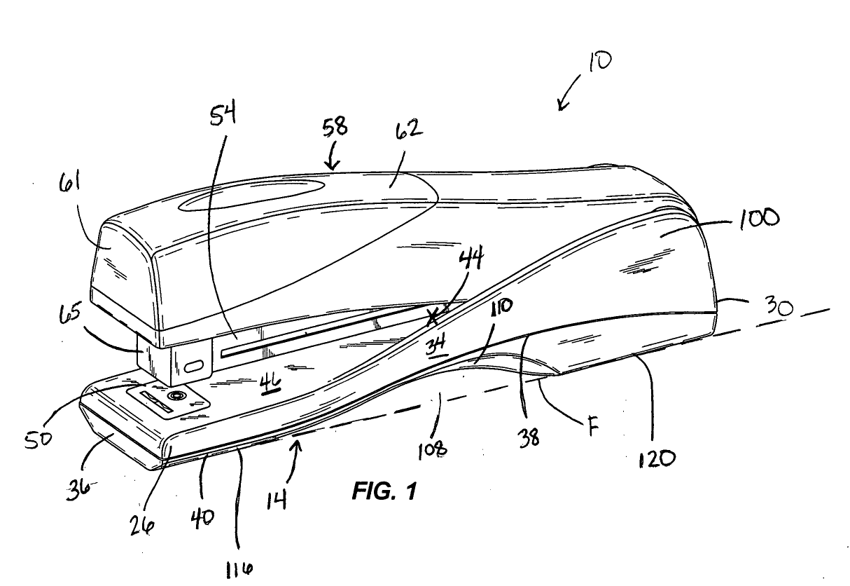

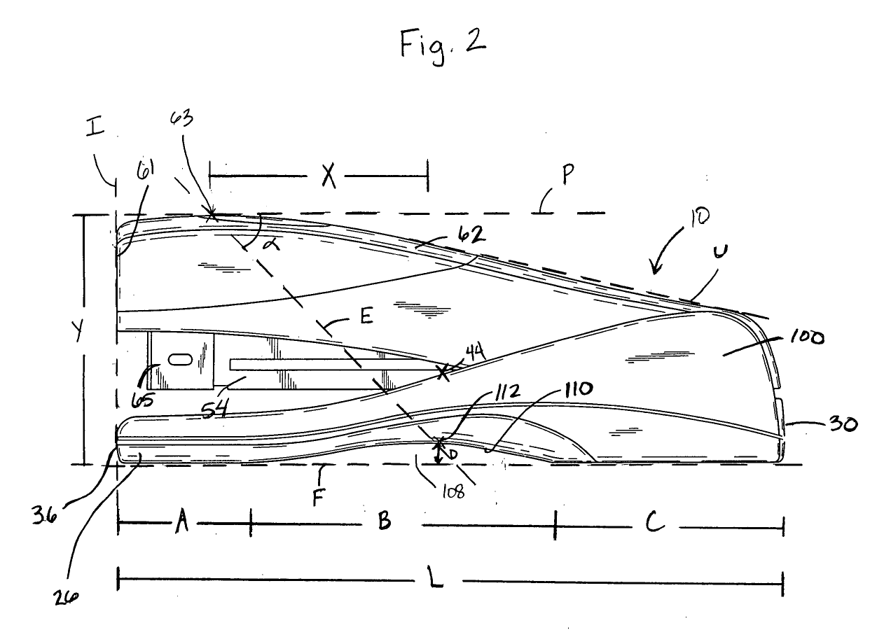

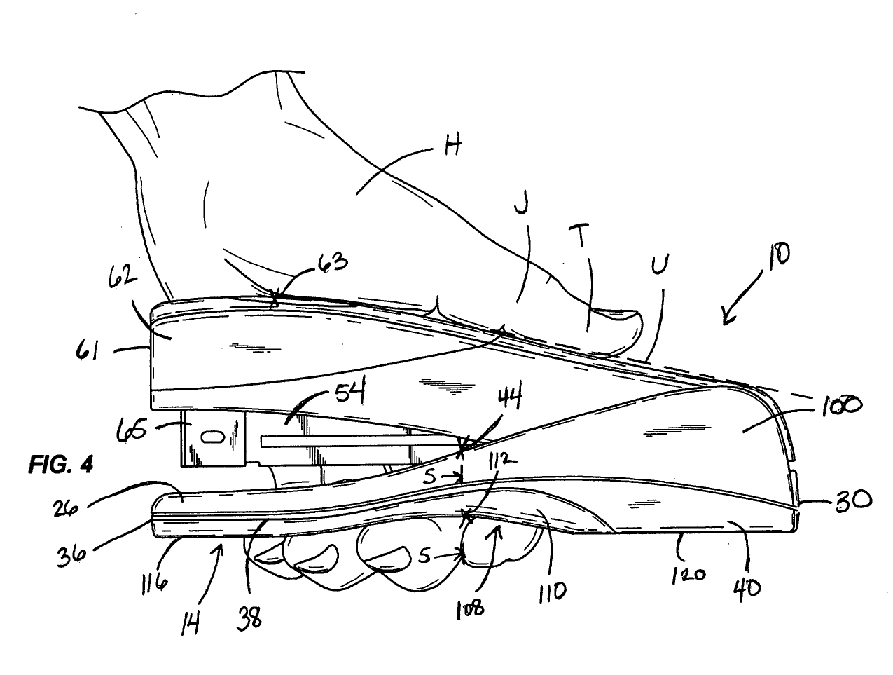

FIGS. 1 and 2 illustrate a stapler 10 embodying the present invention. The illustrated stapler 10 includes a stapler base 14 having a front end 26, a rear end 30, and opposite sides 34. The front end 26 defines a front surface 36. A bottom 38 of the illustrated base 14 includes a slipper or pad 40 that helps stabilize and minimize sliding movement of the stapler 10 on a support surface (not shown), such as a desk. The pad 40 also provides a more comfortable gripping surface for the user when the stapler 10 is used as a hand-held stapler, and increases the friction between the bottom 38 of the base 14 and the user's hand H (shown in FIG. 4) to assist the user in gripping the stapler 10. The illustrated stapler base 14 has a length L approximately equal to 175 mm, and defines a midpoint 44 at about 87.5 mm from each end of the stapler 10. The stapler base 14 also has a width W approximately equal to 40 mm.

The base 14 further includes a top surface 46 for receiving and supporting a stack of sheets (not shown) to be stapled. An anvil 50 is supported by the top surface 46 for clinching staples driven through the stack of sheets. As used herein and in the appended claims, the terms “top”, “bottom”, “upper”, “lower”, “right”, “left”, “front”, “rear”, and the like are intended to facilitate description of the illustrated embodiments, and are not intended to imply or require any particular orientation.

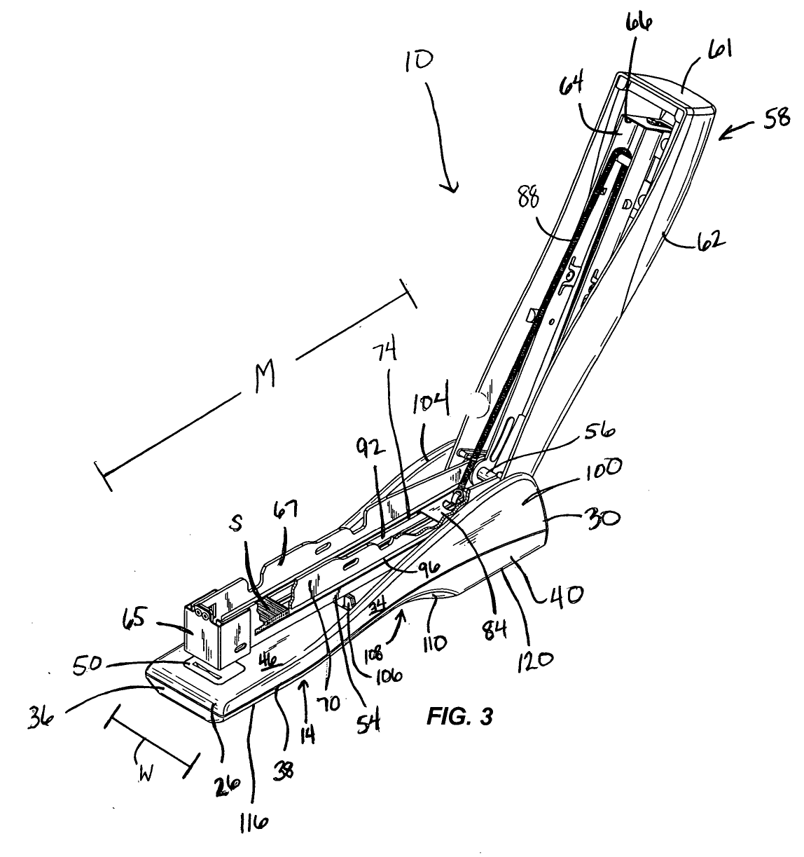

With reference to FIG. 3, a staple magazine 54 is pivotally connected to the rear end 30 of the base 14 at a pivot shaft 56, as is understood in the art. The magazine 54 of the illustrated embodiment has a length M extending between the front of the magazine 54 and the pivot shaft 56 and is approximately equal to 150 mm. A cover assembly 58 is also pivotally connected to the base 14 at the pivot shaft 56, and is capable of pivoting both with the magazine 54 and with respect to the magazine 54 during stapling operations. The cover assembly 58 can be pivoted away from the magazine 54 to facilitate re-filling the magazine 54 with strips of staples S, as shown in FIG. 3. The cover assembly 58 includes a resilient outer cover 62 that can be depressed by the user to actuate the stapler 10.

With reference to FIG. 2, the cover 62 includes an apex 63, which is the point on the cover 62 on which the palm of the users hand will rest when gripping the stapler 10. The height Y from the apex 63 of the cover 62 to the bottom 38 of the base 14 is approximately equal to 67 mm. The front end of the cover 62 includes a front surface 61 that defines a plane I. As illustrated in FIG. 2, the plane I is substantially aligned with the front surface 36 of the base 14. The front surface 61 of the cover 62 and the front surface 36 of the base 14 are substantially flat such that the stapler 10 can rest on the front surfaces 61, 36 as well as on the bottom surface 38 of the base 14 when the stapler 10 is not in use.

Referring back to FIG. 3, a case 64 is also pivotally connected to the base 14 at the pivot shaft 56. The case 64 at least partially closes the upper portion of the magazine 54 when the cover 62 is in the closed position, and pivots with the cover 62 to the open position for re-filling the magazine 54 with staples.

The stapler 10 also includes a driver 66 mounted to the case 64 to drive the staples S out of the stapler 10 into the stack of sheets. The front surface of the driver 66 defines a plane of movement in which the driver 66 moves downwardly to drive the first staple S out of the stapler 10. When the cover assembly 58 is closed, the staple driver 66 is positioned directly above a staple ejection point defined by the front of the magazine 54. As shown in FIG. 4, when a user grips the stapler 10 to use the stapler as a hand-held stapler, the palm of the user's hand rests on the cover 62 directly above the driver 66. The case 64 is pivotable with respect to the outer cover 62 such that the outer cover 62 and the staple driver 66 can move in a staple driving direction (downwardly) relative to the case 64.

The magazine 54 includes a nose piece 65 coupled to the front end of the magazine 54, a first side wall 67 defining interior and exterior surfaces, and a second side wall 70 defining interior and exterior surfaces. The side walls 67 and 70 are coupled together by a bottom wall 74, and are spaced apart a distance approximately equal to the width of the staples to be used with the stapler 10.

As shown in FIG. 3, a staple pusher 84 is positioned within the magazine 54 and is biased toward the front of the magazine 54 to urge the strip of staples S toward the staple ejection point. In the illustrated embodiment, the staple pusher 84 is biased by a spring 88, but other biasing arrangements can also be used. The magazine 54 also includes a rail 92 that supports the underside of the staples S and the staple pusher 84. The rail 92 could be eliminated from within the magazine 54, as magazines without rails are well-known.

The rear end 30 of the base 14 includes a first hip portion 100 and a second hip portion 104. The first and second hip portions 100, 104 extend along either side of the rear end 30 of the base 14, and support the magazine 54 and cover assembly 58 therebetween. The first and second hip portions 100, 104 substantially mirror one another and thus any description of one of the hip portions applies to the other hip portion as well, unless otherwise noted.

The first and second hip portions 100, 104 function to support the magazine 54 and cover assembly 58 when the user actuates the stapler 10. In addition, the hip portions 100, 104 include guides 106 that guide the magazine 54 such that the magazine 54 and cover assembly 58 (and thus, the driver 66) are aligned with the anvil 50 in the top surface 46 of the base. The improved alignment allows for more precise staple placement, and results in a higher sheet capacity for the stapler 10 as the stapler 10 experiences fewer failures based upon improper alignment and clinching of the staples S driven from the stapler 10.

The bottom 38 of the base 14 includes a recess 108 near the midpoint 44 of the stapler. The recess 108 has a length B extending along the base 14. The recess 108 is defined by a curved portion 110 that extends upwardly towards the top surface 46 of the base 14. The recess 108 and curved portion 110 cooperate to form a recess 108 between the bottom 38 of the base 14 and a plane F defined by the support surface (not shown) on which the stapler 10 rests, and defined by a portion of the base 14, as will be discussed below. The recess 108 allows a user to place their hand H around the stapler 10 to grip the stapler during the stapling operation, as shown in FIG. 4. The curved portion 110 extends across the width W of the stapler base 14 to allow the user to grip the stapler 10 before lifting the stapler 10 off of the support surface. Extending the curved portion 110 across the width W of the base 14 thus increases the functionality of the stapler 10 as a hand-held unit.

The bottom 38 of the base 14 also includes a curved portion K that has a radius of curvature in a vertical plane defining a lateral cross section of the stapler 10 approximately equal to 170 mm. In preferred embodiments, the radius of curvature is greater than or equal to 130 mm, and less than or equal to 200 mm. The curved portion K increases the comfort of the user when the user grips the stapler 10, as the curve is designed to follow the natural curvature of the user's hand H.

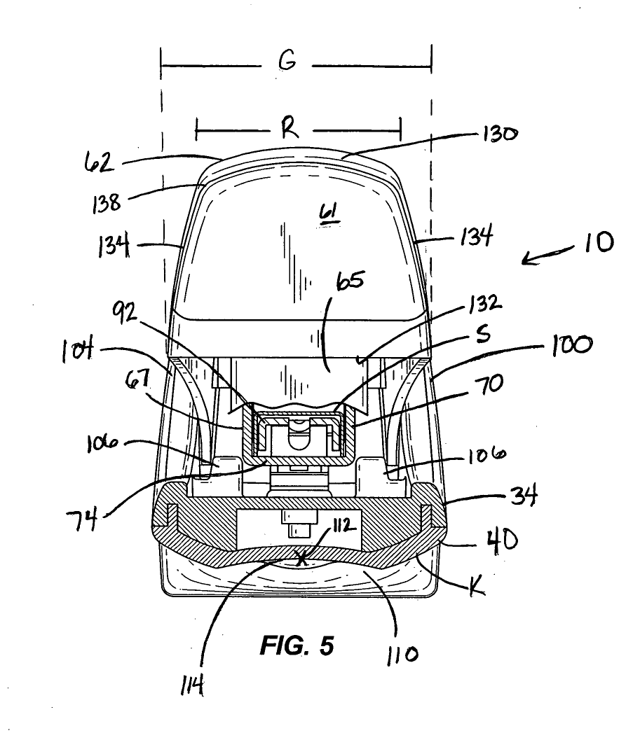

As shown in FIG. 3, the curved portion 110 is concave when the stapler 10 is viewed from the side, and is convex when viewed normal to a vertical, lateral cross section (see FIG. 5). With further reference to FIG. 5, the curved portion 110 includes a concave portion 114 when viewed normal to a vertical, lateral cross section. The concave portion 114 is positioned to receive at least one of the fingers of a user's hand when the stapler is gripped, and is particularly suited to receive the user's forefinger.

The positioning and sizing of the recess 108 and curved portion 110 are chosen to enhance the ergonomic benefits of the stapler 10. The radius of the curved portion 110 follows the natural curve of the user's hand when the user grips the stapler 10 to provide a comfortable gripping surface. In the illustrated embodiment, the radius of curvature of the curved portion 110 in a vertical plane defining the lateral cross section of the stapler 10 (i.e., the radius of curvature of the convex surface seen in FIG. 5) is approximately equal to 36 mm. The radius of curvature of the curved portion 110 in a vertical plane defining the longitudinal cross section of the stapler 10 is approximately equal to 100 mm, though in preferred embodiments, the radius of curvature is between about 70 mm and 130 mm. The radius of curvature of the concave portion 114 in a vertical plane defining a lateral cross section of the stapler 10 is approximately equal to 150 mm. The recess 108 has a depth D that is measured from the plane F to an apex 112 of the curved portion 110 that is approximately equal to 5.5 mm. The apex 112 of the curved portion 110 is positioned within the concave portion 114. In preferred embodiments, the radius of curvature is less than or equal to 100 mm, and less than or equal to 200 mm.

When the user grips the stapler 10, the palm of the user's hand will rest approximately on the apex 63 of the cover 62, as described above, and the index finger of the user's hand will rest approximately on the apex 112 of the curved portion 110. The horizontal distance X between the apex 63 and the apex 112 is approximately equal to 64 mm. The horizontal distance X approximately represents the grip length of the user, as X extends between the user's palm on the top of the cover 62 and the user's fingers on the underside of the base 14 at about the apex 112 of the curved portion 110. The angle α formed between a plane P extending parallel to the plane F and including the apex 63 of the cover, and a plane E intersecting the apex 63 of the cover 62 and the apex 112 of the curved portion 110 is approximately equal to forty-seven degrees. The ratio of the horizontal distance X to the height Y is 64 mm:67 mm, or approximately 1:1.

The recess 108 in the bottom 38 of the base 14 increases the functionality of the stapler 10 by making it easier for a user to grip and lift the stapler 10 to use the stapler 10 as a hand-held stapler. The curved portion 110 is located at or near the midpoint 44 of the stapler, which allows the user to grip and balance the stapler 10 easily, while still allowing the user to exert enough force through the driver 66 to drive a staple S through a stack of sheets. The curved portion 110 has a radius of curvature in a vertical plane defining a longitudinal cross section of approximately 100 mm, and a radius of curvature in a vertical plane defining a lateral cross section of approximately 130 mm.

The bottom 38 also includes first and second flat portions 116, 120 on the front end 26 and rear end 30, respectively, of the base 14. The first and second flat portions 116, 120 are in contact with the support surface when the stapler 10 is resting on the support surface and support the stapler 10 on the surface such that the first and second flat portions 116, 120 are coplanar with and further define the plane F. Thus, when a user wishes to utilize the stapler 10 as a desktop stapler, such as when stapling together a greater number of sheets, the first and second flat portions 116, 120 of the base 14 stabilize the stapler 10 while it rests on the support surface. The first flat portion 116 has a length A extending along the base 14, and the second flat portion 120 has a length C.

Enhancing both the ease of gripping the stapler 10 for use as a hand-held and the desktop stability of the stapler 10 results from the geometry of the base 14. Improving the grip ease and grip comfort is accomplished by increasing the length of the recess 108, as well as modifying the radius of curvature of the curved portion 110 and the depth D of the recess 108. However, with increased recess length comes a reduction in the length of the flat portions of the base 14 available for stapler stability when used as a desktop stapler. On the other hand, increasing the length of the first and second flat portions 116, 120 for supporting the stapler 10 on the support surface reduces the recess 108 available to the user, which makes the stapler 10 more difficult to grip when used as a hand-held.

The geometry of the stapler base 14 that best balances desktop stability with grip comfort can be defined as the ratio of the flat areas to the curved areas. This ratio is represented by the following formula:
(A+C):B.

In the preferred embodiment, the ratio is less than or equal to about 2:1, and is greater than or equal to about 1:1. In a more preferred embodiment, the ratio is less than or equal to about 1.5:1. As shown in FIG. 2, the length B of the recess 108 is approximately equal to 77 mm. The length A of the first flat portion 116 is approximately equal to 36 mm, and the length C of the second flat portion 120 is approximately equal to 62 mm. Thus, in the illustrated embodiment, the ratio of the first and second flat portions to the curved areas is approximately equal to 1.3:1.

The ratio of the lengths of the first and second flat portions 112, 116 with respect to the length L of the stapler base 14 are also illustrative of the enhanced geometry of the stapler 10. In a preferred embodiment, the total length of the flat portions greater than or equal to 40% of the length L of the base 14, and less than or equal to 80% of the length L. In a more preferred embodiment, the total length of the flat portions greater than or equal to 50% of the length L of the base and less than or equal to 70% of the length L. In the illustrated stapler 20, the ratio of the lengths of the first and second flat portions 112, 116 with respect to the length L of the base 14 is equal to (36=62)/175, or approximately 56% of the length of the base 14.

Thus, the configuration of the base 14 improves the ergonomics of the stapler when it is used as a hand-held stapler, and provides for a dual-purpose stapler that can be comfortably and easily used as a hand-held, as well as providing for easy and stable use as a desktop-type stapler.

The configuration of the cover 62 further improves the ergonomics of the stapler. As discussed above, the front end of the cover 62 includes a front surface 61. The front end of the cover 62 includes a radius of curvature in a vertical plane defining a lateral cross section of the stapler 10 approximately equal to 32 mm. The cover 62 also includes a top portion 130, a bottom portion 132, and two sidewalls 134 that extend downwardly from the top portion 130 to the bottom portion 132. With reference to FIG. 5, the front end of the cover 62 includes a first width R measured at the top portion 130 of the cover 62, and a second width G measured along the bottom portion 132. As shown in FIG. 5, the second width G is greater than the first width R such that the sidewalls 134 flare outwardly from the top portion 130 to the bottom portion 132. In a preferred embodiment, the first width R is between about 60% and 85% of the second width G.

In the illustrated embodiment, the first width R is approximately equal to 26 mm and the second width G is approximately equal to 35 mm. Thus, the first width R is approximately 75% of the second width G. The flaring of the sidewalls 134 (i.e., the difference between the first and second widths R, G) is configured to enhance the ability of the user to grip the stapler, with the geometry including sharp enough curves such that the stapler 10 will rest firmly in the hand of the user, but soft enough that the stapler is comfortable in the user's hand.

To that end, the portion 138 of the cover 62 that transitions from the sidewalls 134 to the top portion 130 has a radius of curvature approximately equal to 5 mm. This curve assures a firm, yet comfortable grip on the stapler 10 by the user. It is understood that in other preferred embodiments, the radius of curvature of the portion 138 is greater than or equal to approximately 3 mm, and is less than or equal to approximately 10 mm.

With reference to FIG. 4, the cover 62 is also curved from the front end to the rear end of the stapler 10. The cover 62 includes a curved portion (peaking at the apex 63) that is convex in a plane defining the longitudinal cross section of the stapler 10, and has a radius of curvature in that plane approximately equal to 170 mm for receiving the palm of the user's hand H, and a curved portion (including the point 140 on the cover 62 where the pad of the user's thumb T rests in FIG. 4) that is concave in the plane defining the longitudinal cross section of the stapler 10 (see reference line U in FIGS. 2 and 4, which illustrates the concavity). The concave portion has a radius of curvature that is greater than the curvature of the convex portion, and in the illustrated embodiment is approximately equal to 520 mm. It is understood that in preferred embodiments, the radius of curvature of the convex portion is greater than or equal to approximately 140 mm and is less than or equal to approximately 200 mm. It is also understood that in preferred embodiments, the radius of curvature of the concave portion is greater than or equal to 480 mm approximately and is less than or equal to approximately 600 mm. Thus, the radius of curvature of the convex portion is between about 20% and 45% of the radius of the concave portion, and in the illustrated embodiment is approximately equal to 33% of the radius of curvature of the concave portion.

Extending between the convex and concave portions discussed above is a central portion upon which the first knuckle J of the user's thumb T rests. The central portion has a much flatter curve than the convex or concave portions, and has a radius of curvature in a vertical plane defining a longitudinal cross section of the stapler 10 of approximately 950 mm, and a radius of curvature in a vertical plane defining a lateral cross section of the stapler 10 approximately equal to 50 mm.

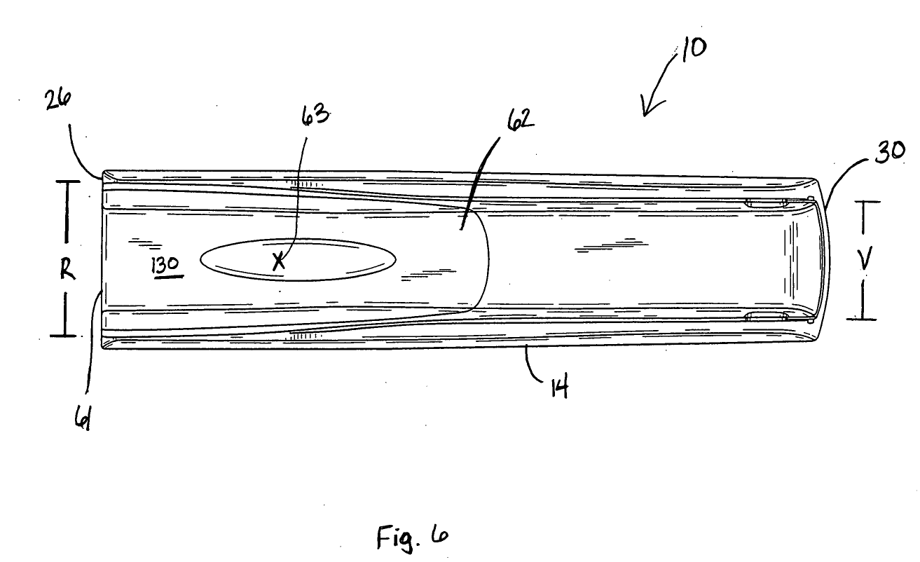

Further, and as shown in FIG. 6, the cover 62 has a second, rear end having a width V that is approximately equal to 23. The second end has a radius of curvature in a vertical plane defining a lateral cross section of the stapler 10 of about 40 mm. Thus, the width V of the second end is approximately equal to 88% of the first width R of the front end. The tapering of the cover 62 from the front end to the rear end further improves the grip by the user as the wider portion near the front end is seated within the palm of the user's hand H when the stapler 10 is gripped, and the second (rear) end of the cover 62 is sized to be comfortably gripped by the user's fingers. In preferred embodiments, the width V is between approximately 70% and 95% of the width R.

While either the geometry of the base 14 or the cover 62 as described above is alone enough to enhance the functionality and ergonomics of the stapler 10 such that the stapler can be used either as a desktop-type stapler or a hand-held stapler, combining the base 14 and cover 62 and the geometries discussed above further enhances the stapler. The curvatures of the base 14 and the cover 62 work together to receive various parts of the user's hand H during gripping, providing a stable, comfortable grip, as well as allowing the stapler 10 to be well-supported on a support surface when used as a desktop stapler. In various preferred embodiments of the invention, the stapler 10 may include the base 14 and/or cover 62 of the illustrated embodiment, or may include various features thereof in combination with each other. The result is a stapler having improved ergonomics that is versatile enough to be used in multiple ways to achieve the benefits of both a hand-held and desktop stapler.

Various features of the invention can be found in the following claims.

We claim:

1. A stapler configured such that the stapler can be used as both a desktop-type stapler and as a hand-held stapler, the stapler comprising:
a base defining a base length and a base width, the base comprising
a front end,
a rear end,
a top surface, and
a bottom surface, the bottom surface including a first flat portion near the front end of the base, a second flat portion near the rear end of the base, and a recess extending substantially the entire distance between the first and second flat portions, the flat portions defining a plane;
a staple magazine pivotably coupled to the base and configured to hold staples;
a cover assembly coupled to the base for movement during stapling operations; and
a staple driver coupled to the cover assembly configured to drive staples out of the staple magazine during stapling operations;
wherein the recess includes a curved portion that extends across the width of the stapler base, and wherein the curved portion is raised upwardly from the plane defined by the first and second flat portions along the length between the first and second flat portions.

2. The stapler of claim 1, wherein the top surface of the base includes an anvil.

3. The stapler of claim 1, wherein the first flat portion has a length approximately equal to 36 mm, and wherein the second flat portion has a length approximately equal to 62 mm.

4. The stapler of claim 1, wherein the recess has a length of approximately 77 mm, and wherein the recess has a depth extending upwardly from the plane defined by the first and second flat portions of approximately 5.5 mm.

5. The stapler of claim 1, wherein the geometry of the base is configured to optimize both desktop stability with ease and comfort of use as a hand-held stapler, and wherein the optimization is represented by the ratio of the length of the first and second flat portions to the length of the recess.

6. The stapler of claim 5, wherein the ratio is less than or equal to about 1.5:1, and greater than or equal to about 1:1.

7. The stapler of claim 6, wherein the ratio is about 1.3:1.

8. The stapler of claim 1, wherein the stapler has a height extending between an apex of the cover assembly and the plane defined by the first and second flat portions, and wherein the stapler has a horizontal distance extending between the apex of the cover assembly and an apex of the recess such that the ratio of the horizontal distance to the height is approximately equal to 1:1.

9. The stapler of claim 1, wherein the cover assembly includes an outer cover, and wherein the outer cover is configured to receive a palm of a user's hand directly above the driver when the stapler is gripped, and wherein the recess is configured to receive at least one of another one of the fingers of the user's hand.

10. The stapler of claim 1, wherein the cover assembly includes an outer cover, and wherein the cover a first end adjacent the first end of the base, the first end having a first width and a second width, the first end having a first radius of curvature in a convex direction in a plane defining a longitudinal cross section of the stapler, and a second end adjacent the second end of the base, the second end having a width and having a second radius of curvature in a concave direction in the plane defining the longitudinal cross section of the stapler, and wherein the first width of the first end is greater than the width of the second end, and wherein the convex radius of curvature is less than the concave radius of curvature.

11. A stapler base having a base length and a base width, the base comprising:
a front end;
a rear end;
a top surface, the top surface including an anvil; and
a bottom surface, the bottom surface including
a first flat portion near the front end of the base and having a length,
a second flat portion near the rear end of the base and having a length, and
a recess positioned between the first and second flat portions and having a length, the first and second flat portions defining a plane;
wherein the bottom surface of the base has a geometry defined by a ratio of the combined length of the first and second flat portions with respect to the length of the recess, and wherein the ratio is greater than or equal to about 1:1 and less than or equal to about 2:1.

12. The stapler base of claim 11, wherein the base length is equal to the length of the first and second flat portions added to the length of the recess such that the first and second flat portions and the recess extend along the entirety of the base length.

13. The stapler base of claim 11, wherein the first flat portion has a length approximately equal to 36 mm, and wherein the second flat portion has a length approximately equal to 62 mm.

14. The stapler base of claim 11, wherein the recess has a length of approximately 77 mm, and wherein the recess has a depth extending upwardly from the plane defined by the first and second flat portions of approximately 5.5 mm.

15. The stapler base of claim 11, wherein the ratio is less than or equal to about 1.5:1, and greater than or equal to about 1:1.

16. The stapler base of claim 1, wherein the ratio is about 1.3:1.

17. The stapler base of claim 11, wherein the recess extends across the entire width of the base.

18. A stapler configured such that the stapler can be used as both a desktop-type stapler and as a hand-held stapler, the stapler comprising:
a base having a base length, the base including a front end, a rear end, a top surface, and a bottom surface, the front end of the base having a front surface, and the bottom surface of the base including a first flat portion near the front end of the base, a second flat portion near the rear end of the base, and a recess extending between the flat portions, the first and second flat portions each having a length;
a staple magazine pivotably coupled to the base and configured to hold staples; and
a cover coupled to the base for movement during stapling operations, the cover having a front surface, the front surface of the cover defining a plane that substantially intersects the front surface of the base;
wherein the combined length of the first and second flat portions is greater than or equal to about 40% of the base length, and is less than or equal to about 80% of the base length.

19. The stapler of claim 18, wherein the combined length of the first and second flat portions is greater than or equal to about 50% of the base length, and is less than or equal to about 70% of the base length.

20. The stapler of claim 18, wherein the combined length of the first and second flat portions is equal to approximately 56% of the base length.

21. The stapler of claim 18, wherein the geometry of the base is configured to optimize both desktop stability with ease and comfort of use as a hand-held stapler, and wherein the optimization is represented by the ratio of the length of the first and second flat portions to the length of the recess.

22. The stapler of claim 21, wherein the ratio is less than or equal to about 1.5:1, and greater than or equal to about 1:1.

23. The stapler of claim 21, wherein the ratio is about 1.3:1.

24. The stapler of claim 18, wherein the base length is equal to the length of the first and second flat portions added to the length of the recess such that the first and second flat portions and the recess extend along the entirety of the base length.

25. The stapler of claim 18, wherein the cover includes a first end adjacent the first end of the base, the first end having a first width and a second width, the first end having a first radius of curvature in a convex direction in a plane defining a longitudinal cross section of the stapler, and a second end adjacent the second end of the base, the second end having a width and having a second radius of curvature in a concave direction in the plane defining the longitudinal cross section of the stapler, and wherein the first width of the first end is greater than the width of the second end.

26. A stapler configured such that the stapler can be used both as a desktop-type stapler and as a hand-held stapler, the stapler comprising:
a base having a first end and a second end;
a staple magazine coupled to the base and configured to hold staples; and
a cover assembly coupled to the magazine, the cover assembly including a cover that can be depressed by a user to actuate the stapler, the cover including
a first end adjacent the first end of the base, the first end having a first width and a second width, the first end having a first radius of curvature in a convex direction in a plane defining a longitudinal cross section of the stapler, and
a second end adjacent the second end of the base, the second end having a width and having a second radius of curvature in a concave direction in the plane defining the longitudinal cross section of the stapler;
wherein the first width of the first end is greater than the width of the second end, and wherein the convex radius of curvature is less than the concave radius of curvature.

27. The stapler of claim 26, wherein the second width of the first end is greater than the first width of the first end.

28. The stapler of claim 26, wherein the base has a length, the base including a first end, a second end, a top surface, and a bottom surface, the bottom surface including a flat portion having a length, and wherein the length of the flat portion is greater than or equal to about 40% of the length of the base.

29. A stapler configured such that the stapler can be used both as a desktop-type stapler and as a hand-held stapler, the stapler comprising:
a base having a length, the base including a first end, a second end, a top surface, and a bottom surface, the bottom surface including a flat portion having a length;
a staple magazine coupled to the base and configured to hold staples; and
a cover assembly coupled to the magazine, the cover assembly including a cover that can be depressed by a user to actuate the stapler, the cover including
a first end adjacent the first end of the base, the first end having a first width and a second width, the first end having a first radius of curvature in a convex direction in a plane defining a longitudinal cross section of the stapler, and
a second end adjacent the second end of the base, the second end having a width and having a second radius of curvature in a concave direction in the plane defining the longitudinal cross section of the stapler;
wherein the first width of the first end is greater than the width of the second end, and wherein the length of the flat portion is greater than or equal to about 40% of the length of the base.

30. The stapler of claim 29, wherein the second width of the first end is greater than the first width of the first end.
